(19) United States
(12) Patent Application Publication
(10) Pub. No.: US 2011/0061999 A1
(43) Pub. Date: Mar. 17, 2011

(54) NON-CONTACT TYPE OF VACUUM PAD

(76) Inventor: Ho-Young Cho, Gyeonggi-do (KR)

(21) Appl. No.: 12/736,796

(22) PCT Filed: Mar. 17, 2009
(86) PCT No.: PCT/KR2009/001317

§ 371 Date: Nov. 9, 2010

(30) Foreign Application Priority Data
May 13, 2008 (KR) 10-2008-0043850

(51) Int. Cl. B65G 17/46

(52) U.S. Cl. 198/689.1

(57) ABSTRACT

The present invention relates to a non-contact type vacuum pad which is used for holding articles in a vacuum conveying system. The vacuum pad of the present invention comprises a main body, an air guide, and a discharge pathway formed by means of the main body and guide. The air guide is attached in such a way that it does not project from the bottom edge of the main body, and it has: a central inflow recess communicating with a supply hole; one or more flow pathways formed passing through the wall surface from the inflow recess; and a suction hole which extends from the bottom surface and connects to be flow pathway(s). When compressed air passes through the flow pathway(s), the outside air underneath the vacuum pad passes the vicinity of a diffusing surface and through the suction hole and is entrained into the compressed air, and merges with and is discharged together with the compressed air. At this time, articles can be strongly held due to the negative pressure produced in the space between the vacuum pad and the article.

### TECHNICAL FIELD

The present invention relates, in general, to a vacuum pad which is utilized for holding an article in a vacuum conveying system and, more particularly, to a non-contact type vacuum pad which is capable of holding an article in a non-contact state.

### BACKGROUND ART

A vacuum conveying system is a system that creates negative pressure in a vacuum pad using compressed air and uses the created negative pressure to hold an article so that it can be conveyed to a predetermined place. It is common to use a contact type vacuum pad in this system. However, the contact type vacuum pad is problematic in that it is in direct contact with a surface of the article, so that its surface becomes damaged or contaminated.

Especially, a panel or the like used for a display of an electronic product is susceptible to fine scratches or deformation or impurities, so that the contact type pad is unsuitable for conveying the article. Thus, recently, the demand for a non-contact type pad is gradually increasing.

Conventional non-contact type vacuum pads are illustrated in FIGS. 1 and 2. The same reference numerals are used in the two drawings to designate the same or similar components. As shown in the drawings, each non-contact type vacuum pad includes a main body 1 which has in a central portion thereof a compressed-air supply hole 2, and a guide 3 which is coupled to the lower portion of the main body 1, thus guiding the flow of air in a lateral direction.

The compressed air, which is supplied through the supply hole 2 of the main body 1 into the vacuum pad, is guided in the lateral direction by the guide 3, and passes through the edge of the lower surface of the main body 1 at high speed to be discharged to the outside. At this time, according to the Bernoulli effect, a vacuum is created between the vacuum pad and an article P, and negative pressure is generated by a difference in pressure between the vacuum and the atmospheric pressure.

The negative pressure causes the article P to come in proximity to and be held by the vacuum pad. However, a non-contact state is maintained between the vacuum pad and the article P, because they are spaced apart from each other by a minimum gap d by the discharge pressure of the compressed air. For this reason, it is called a non-contact type vacuum pad.

When comparing the non-contact type vacuum pad with the contact type pad, the non-contact type vacuum pad is considerably advantageous in the handling of an article that needs to maintain a precision surface. However, this type of vacuum pad is problematic in that there is a limitation with respect to the vacuum strength that can be achieved, and it takes a long time to reach the maximum of the strength. Thus, it is not reliably used to handle an article that is heavy.

For example, the non-contact type vacuum pad may obtain a higher vacuum strength by supplying a larger amount of compressed air at higher speed, and discharging the compressed air at higher speed. However, in this case, there is an excessively large amount of energy consumed.

As another prior art, a non-contact type gripper is disclosed in Korean U.M. Registration No. 401259. The gripper includes a vacuum hose which passes through a non-contact pad corresponding to the guide 3 and extends to the outside. Although not explained therein, the vacuum hose is connected to a separate vacuum pump.

In the gripper, the vacuum pump is driven so that air present underneath the non-contact pad is forcibly discharged. Thus, compared to the non-contact type vacuum pad, the gripper can more rapidly obtain a stronger vacuum. However, the gripper is problematic in that it requires a complex design including the vacuum hose, its mounting structure, and the vacuum pump. Further, the gripper is problematic in that energy for driving the vacuum pump as well as energy for holding an article is required.

### DISCLOSURE

### Technical Problem

Accordingly, the present invention has been made keeping in mind the above problems occurring in the prior art, and an object of the present invention is to provide a vacuum pad, which is capable of obtaining a reliable level of negative pressure and a reliably strong vacuum when handling an article that is heavy.

Another object of the present invention is to provide a non-contact type vacuum pad, which can improve energy efficiency using a simple design, thus being very advantageous in an economic point of view.

### Technical Solution

In order to accomplish the above objects, the present invention provides a non-contact type vacuum pad including a main body, an air guide, and a discharge passage defined by the main body and the guide. The main body has a compressed-air supply hole formed in a central portion thereof, and an outwardly flared surface formed on a lower end of the supply hole. Such a construction is not different from the conventional vacuum pad.

The air guide is mounted to the main body in such a way that the air guide does not protrude from a bottom edge of the main body, and has a central inflow recess which communicates with the supply hole, at least one flow pathway which is formed from the inflow recess through a wall surface, and a suction hole which extends from a bottom surface and is connected to the flow pathway. Further, the discharge passage is the passage through which compressed air supplied to the supply hole is discharged, and extends from the flow pathway of the guide to the flared surface and the edge of the main body,

Preferably, the flow pathway may comprise a plurality of flow pathways which are radially arranged around the inflow recess. More preferably, each flow pathway may comprise flow pathways which are arranged in series and in multiple stages. The suction hole may be formed between neighboring flow pathways. The suction hole may have an annular shape. Preferably, the suction hole may have on a lower end thereof a flared surface. Such a construction is useful for rapidly and smoothly sucking in outside air.

Further, preferably, a lower surface of a middle portion of the guide may be placed to be further inside than a lower surface of an outer portion of the guide. Such a configuration provides a larger vacuum space as compared to the configuration wherein the lower surface of the central portion of the guide is on the same level with the lower surface of the outer portion, thus attaining a larger vacuum space, therefore obtaining a stronger vacuum and greater holding force.

### ADVANTAGEOUS EFFECTS

According to the present invention, a vacuum pad is advantageous in that, when compressed air passes through a discharge passage at high speed, outside air present underneath the vacuum pad is sucked in and then is discharged along with the compressed air, so that a higher vacuum strength is more rapidly achieved. Thus, the vacuum pad is advantageous in that it can be reliably applied when handling an article that is heavy. Meanwhile, in order to accomplish the effect, a complex design, a larger amount of energy or an additional energy source are not required. Therefore, the vacuum pad is very advantageous in terms of economics and energy efficiency.

### DESCRIPTION OF DRAWINGS

FIG. 1 is a sectional view showing a conventional non-contact type vacuum pad;

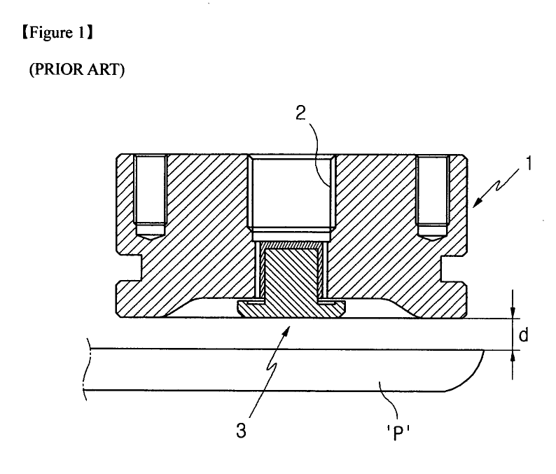

FIG. 2 is a sectional view showing another conventional non-contact type vacuum pad;

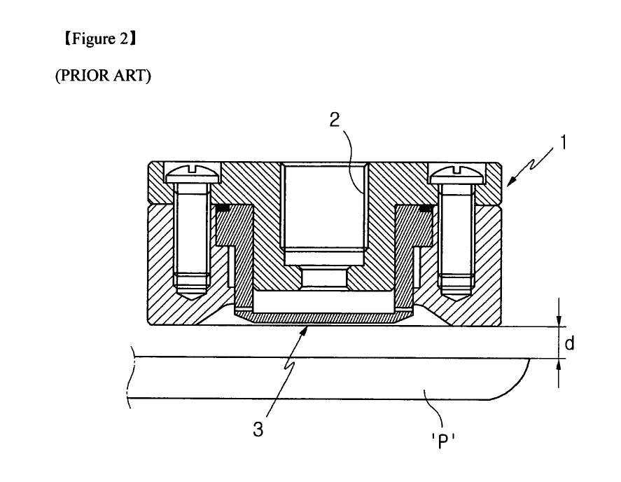

FIG. 3 is a sectional view showing a non-contact type vacuum pad according to the present invention;

FIG. 4 is a bottom view showing an air guide applied to FIG. 3; and

FIG. 5 is a view illustrating the operation of the non-contact type vacuum pad according to the present invention.

### DESCRIPTION OF REFERENCE CHARACTERS OF IMPORTANT PARTS

| | |
|---|---|
| 11. main body | 12. guide |
| 13. supply hole | 14. flared surface |
| 18. flow pathway | 19. suction hole |
| 20. flared surface | |

### MODE FOR INVENTION

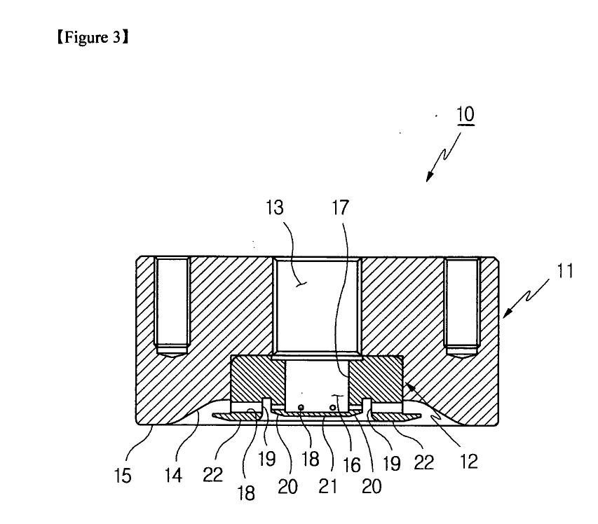

The above or other characteristics and effects of the present invention may be more obvious based on the description of the embodiment of the present invention which is illustrated below with reference to FIGS. 3 to 5.

Referring to FIG. 3, a non-contact type vacuum pad of the present invention is denoted by reference numeral 10. The vacuum pad 10 includes a main body 11, a guide 12 which is coupled to the lower portion of the main body 11, and a compressed-air discharge passage which is provided between the main body 11 and the guide 12. Here, the main body 11 has a compressed-air supply hole 13 which is formed in the central portion of the main body, and an outwardly flared surface 14 which is formed on the lower end of the supply hole 13. The construction is not different from that of the conventional vacuum pad. However, the outwardly flared surface may be selected from an inclined surface or a round surface.

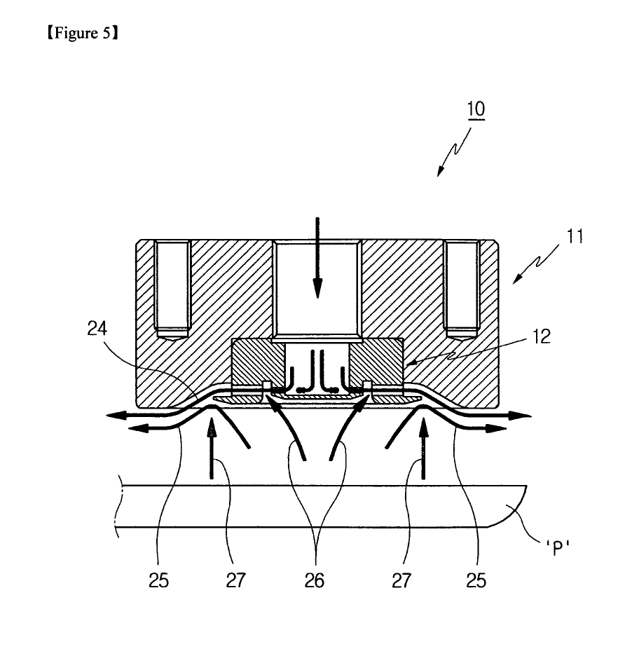

The air guide 12 is mounted to the main body 11 in such a way that it does not protrude from a bottom edge 15 of the main body. Preferably, the air guide is mounted to the main body 11 in such a way that it does not protrude from the outwardly flared surface 14 formed on the lower end of the supply hole 13. For example, if the guide 12 protrudes, the vacuum pad 10 may make contact with an article ‘P’ (see FIG. 5).

The air guide 12 includes a central inflow recess 16 which communicates with the supply hole 13, at least one flow pathway 18 which is formed from the inflow recess 16 through a wall surface 17, and a suction hole 19 which extends from a bottom surface and is connected to the flow pathway 18. Although not shown in the drawings, a pipe-type nozzle may be mounted to the flow pathway 18.

The discharge passage is the place through which compressed air supplied to the supply hole 13 of the main body 11 is discharged, and extends from the flow pathway 18 of the guide 12 to the flared surface 14 and the edge 15 of the main body 11.

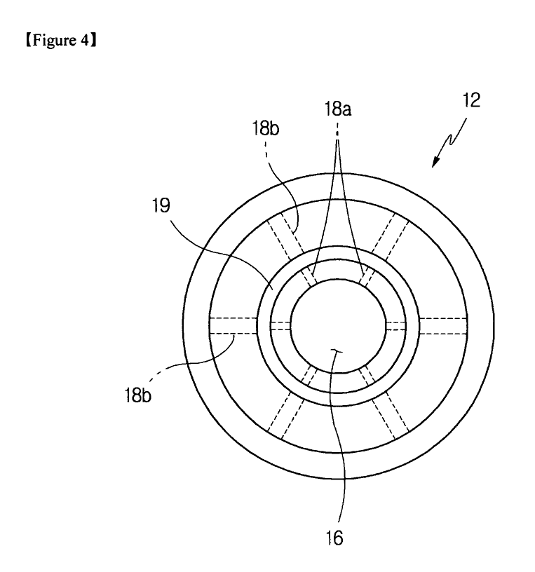

Referring to FIG. 4, a plurality of flow pathways 18 is formed in the guide 12 to be radially arranged around the inflow recess 16. If there are too many flow pathways 18, the speed at which the compressed air is discharged may be reduced. In order to solve the problem, it is necessary to ascertain what is the proper number of flow pathways. In the drawing, the suction hole 19 has the shape of one ring and communicates with each flow pathway 18. Such a construction is useful for rapidly and smoothly sucking in outside air, namely, air between the vacuum pad 10 and the article ‘P’ (see FIG. 5).

Each flow pathway 18 comprises flow pathways 18a and 18b which are arranged in series and in multiple stages in such a way that their diameters are increased. The suction hole 19 is placed between neighboring flow pathways 18a and 18b. Compressed air passes through the flow pathway 18a having a small diameter at the highest speed. Hence, outside air is introduced into the compressed air through the suction hole 19. Further, the outside air is combined with the compressed air at the flow pathway 18b having a large diameter and then discharged together with the compressed air. Such a shape of the flow pathway 18 is very effective in discharging the outside air.

Turning back to FIG. 3, the suction hole 19 has on the lower end thereof a flared surface 20. Such a construction is useful for rapidly and smoothly sucking in outside air underneath the vacuum pad 10. Meanwhile, a lower surface 21 of a middle portion of the guide 12 is placed to be further inside than a lower surface 22 of an outer portion thereof. Such a configuration provides a larger vacuum space in comparison with the configuration wherein the lower surface of the middle portion is on the same level with that of the outer portion. Thus, the vacuum pad 10 can attain a stronger vacuum and a greater holding force.

The lower surface 22 of the outer portion of the guide 12 extends and protrudes leftwards and rightwards. This guides the compressed air such that it is naturally discharged along the flared surface 14 after passing through the flow pathway 18.

Referring to FIG. 5, compressed air is supplied to the supply hole 13 of the main body 11, and flows into the inflow recess 16 of the guide 12. The compressed air then in sequence passes through the discharge passage, that is, the flow pathway 18, the flared surface 14, and the edge 15 and then is discharged to the outside (see arrows 24).

In this process, Bernoulli's effect is in effect. That is, some of the air present between the vacuum pad 10 and the article P is combined with the compressed air in the vicinity of the flared surface 14 and is discharged together with the compressed air (see arrows 25). Simultaneously, other air between the vacuum pad 10 and the article P passes through the suction hole 19, is introduced into the compressed air, and is combined with the compressed air at the flow pathway 18b to be discharged together with the compressed air (see arrows 26).

Thereby, vacuum and negative pressure are generated between the vacuum pad 10 and the article P, and the generated negative pressure causes the article P to come in proximity to and be held by the vacuum pad 10 (see arrows 27).

The above-mentioned vacuum pad 10 is constructed so that, when the compressed air passes through the discharge passage, the outside air existing underneath the vacuum pad is introduced into the compressed air in the vicinity of the flared surface 14 and through the suction hole 19, and is combined with the compressed air to be discharged together with the compressed air. Therefore, a very strong vacuum and negative pressure can be more rapidly created. Further, it is obvious that a complex design, a large amount of energy or an additional energy source are not required to accomplish the rapid creation of a strong vacuum and strong negative pressure.

1. A non-contact type vacuum pad, comprising:
a main body having a compressed-air supply hole formed in a central portion thereof, and an outwardly flared surface formed on a lower end of the supply hole;
an air guide mounted to the main body in such a way that the air guide does not protrude from a bottom edge of the main body, and having a central inflow recess which communicates with the supply hole, at least one flow pathway which is formed from the inflow recess through a wall surface, and a suction hole which extends from a bottom surface and is connected to the flow pathway;
a compressed-air discharge passage extending from the flow pathway of the guide to the flared surface and the edge of the main body,
wherein the flow pathway comprises flow pathways which are arranged in series and in multiple stages such that diameters of the flow pathways are increased, the suction hole being placed between neighboring flow pathways.

2. The non-contact type vacuum pad according to claim 1, wherein the flow pathway comprises a plurality of flow pathways which are radially arranged around the inflow recess.

3. The non-contact type vacuum pad according to claim 1, wherein the suction hole has an annular shape.

4. The non-contact type vacuum pad according to claim 1, wherein the suction hole has on a lower end thereof a flared surface.

5. The non-contact type vacuum pad according to claim 1, wherein a lower surface of a middle portion of the guide is placed to be further inside than a lower surface of an outer portion of the guide.

6. The non-contact type vacuum pad according to claim 1, wherein a pipe-type nozzle is mounted in the flow pathway.

7. The non-contact type vacuum pad according to claim 1, wherein the outwardly flared surface of the main body is an inclined surface or a round surface.

8. The non-contact type vacuum pad according to claim 1, wherein the lower surface of the outer portion of the guide extends and protrudes leftwards and rightwards.
